(19) United States
(12) Patent Application Publication
(10) Pub. No.: US 2004/0032399 A1
(43) Pub. Date: Feb. 19, 2004

(54) Ultrasonic coordinate input apparatus

(75) Inventors: Hidenori Sekiguchi, Kawasaki (JP); Soichi Hama, Kawasaki (JP); Akira Fujii, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/639,653

(22) Filed: Aug. 13, 2003

(30) Foreign Application Priority Data
Aug. 15, 2002 (JP) 2002-236945

(51) Int. Cl. G09G 5/00

(52) U.S. Cl. 345/173

(57) ABSTRACT

An ultrasonic coordinate input apparatus identifies using ultrasonic waves whether an input pen contacts a handwriting surface or it is held in the air within a predetermined distance, and can input not only a contact input locus but also an aerial movement locus. A receiver of the ultrasonic coordinate input apparatus is fixed to any of the four corners of the handwriting surface in an appropriate method. Infrared and ultrasonic waves are transmitted respectively from an Infrared transmitting unit and an ultrasonic transmission unit of the input pen being used at predetermined intervals. A distance detection unit of the receiver computes and inputs the contact movement locus or the aerial movement locus of the point of the input pen to the handwriting surface using the ultrasonic waves detected by two ultrasonic sensors only when the infrared from the input pen is received at 90° in the horizontal direction and 10° in the vertical direction.

### BACKGROUND OF THE INVENTION

1. Field of the Invention

The present invention relates to a coordinate input apparatus for inputting into a computer the handwriting locus of characters and graphics written with an input pen.

2. Description of the Related Art

Conventionally, to input handwritten characters and pictures into a computer and operate the GUI (user interface including pictures, icons, etc.) on the screen of a display device instead of using a mouse, the technology of attaching a pressure-sensitive film onto the screen of the display device, directly inputting characters and pictures using an input pen commonly called a stylus on the screen of the display device, inputting a selective specification by a handwriting locus and contact using an input pen, etc. into a computer, and displaying the input result on the screen of the display device has become commercially practical.

There has been another technology of obtaining the position of an input pen by electromagnetic induction after setting a grid electrode on the back of a liquid crystal display. Since this system has the sensitivity to electromagnetic induction to detect the position of an input pen which does not contact the surface of the liquid crystal display, the input pen can be moved in the air and its movement locus can be successfully input. Therefore, if the cursor can be moved on the display screen depending on the position of the input pen in the air, a small position error between the point of the input pen and a desired position on the screen, which possibly occurs due to the parallax from the thickness of the display screen, a view angle, etc., can be corrected by closely moving the input pen, thereby affording convenience in using the system. These systems can be referred to as close input, hovering, a flying point, etc.

There also is the technology of placing an exclusive plate referred to as a tablet for inputting coordinates on the desk, not on the screen, using an input pen on the tablet, and inputting the coordinates of the handwriting locus into a computer. In this case, since the user performs an inputting operation on the tablet while watching the display screen of the computer, the user cannot locate the input pen until he or she touches the tablet with the input pen. To solve this problem, an electromagnetic inductive tablet is used for close input.

Furthermore, the electromagnetic induction system has been replaced with an ultrasonic system as a method of obtaining the position coordinates of an input pen. The new system is realized by two types. In the first type system, an ultrasonic pulse is transmitted in the air using an input pen after a notification of a timing of transmitting the ultrasonic pulse through cable, infrared, etc. is transmitted to a fixed side. Then, two fixed ultrasonic sensors receive the ultrasonic pulse, the distance from the input pen is measured based on the reception time, and the position of the input pen can be obtained by triangulation techniques.

In the second type system, there is no timing notification device for transmitting an ultrasonic pulse, and the timing of transmitting an ultrasonic pulse is not known on the fixed side. In this case, three ultrasonic sensors are used to obtain the difference in distance from the time lag in receiving a pulse by each sensor, and to obtain the position of an input pen based on the principle of the hyperbolic navigation.

In any system, the position coordinates of an input pen can be obtained by arranging two or three ultrasonic sensors. Therefore, the configuration of this system is simpler that of the electromagnetic inductive system, thereby providing a less expensive device for users.

In the above mentioned method of attaching a pressure-sensitive film, the position of the input pen cannot be detected until the user touches the surface of the display screen, that is, the pressure-sensitive film surface (the contact locus is not displayed on the display screen). Therefore, when the input pen actually touches the surface of the display screen, there frequently is an error detected between the position of the point of the input pen and a desired position on the display screen due to the parallax, etc. from the thickness of the display screen and the view angle to the screen as described above.

With the above mentioned position error, lines do not correctly continue when the point of the input pen is detached from the display screen for any reason during the writing process and then used to input a line continuing the previously input line. As a result, there arises the problem that a character and a picture cannot be easily written or drawn. Furthermore, there also arises the problem of an incorrect inputting operation on the screen of the GUI, etc.

In the above mentioned electromagnetic inductive system, it is necessary to form the electrode on the back of display screen so that the electromagnetic inductive grid electrode cannot disturb the vision on the display screen. Therefore, the structure of the entire display screen is complicated and correspondingly inflexible in design due to various restrictions from the complicated structure. Furthermore, the complicated structure also raises the price of the resultant device as compared with the common liquid crystal display.

Although it is certain that the conventional ultrasonic system is simple in configuration and the device is less expensive, an ultrasonic pulse can be generated only when the input pen contacts the input surface. Therefore, uses have not been satisfied with the inability to input the aerial movement locus using the input pen as in the close input of the electromagnetic inductive system.

### SUMMARY OF THE INVENTION

The present invention aims at solve the above mentioned problems, and aims at providing an ultrasonic coordinate input apparatus capable of obtaining the position coordinates of an input pen using ultrasonic waves, determining whether the point of the input pen contacts the input surface or is held in the air, and inputting not only an input surface contact locus but also an aerial movement locus of an input pen.

To attain the above mentioned objects, the ultrasonic coordinate input apparatus according to the present invention has a mobile object including an ultrasonic piezoelectric device for transmitting or receiving ultrasonic waves, a contact sensor unit for sensing the contact between a specific portion of the mobile object and a coordinate input surface, a fixed object including at least two ultrasonic piezoelectric devices for receiving or transmitting ultrasonic waves, and a position sensor unit for obtaining the position of the mobile object relative to the fixed object based on the propagation time of the ultrasonic waves, and includes a determination unit for determining whether or not the mobile object inputs coordinates when the specific portion of the mobile object does not contact the coordinate input surface, and a transmission unit for transmitting a signal as to whether or not the specific portion of the mobile object contacts the coordinate input surface from the mobile object to the fixed object.

As described in claim 2, the transmission unit is configured such that the ultrasonic waves can be modulated and transmitted depending on whether or not the specific portion of the mobile object contacts the coordinate input surface.

As described in claim 5, the ultrasonic coordinate input apparatus further includes an electromagnetic wave transmission unit for transmitting electromagnetic waves including light in the mobile object, an electromagnetic wave reception unit for receiving electromagnetic waves including light in the fixed object, and a timing acquisition unit for obtaining a timing of generating the ultrasonic waves by the transmission and reception of the electromagnetic waves. The electromagnetic wave transmission unit is configured such that the electromagnetic waves can be changed and transmitted depending on whether or not the specific portion of the mobile object contacts the coordinate input surface.

As described in claim 10, the determination unit includes a distance detection unit for detecting the distance between the mobile object and the coordinate input surface, and is configured to input the coordinates by the mobile object when the distance detected by the distance detection unit is within a predetermined distance although the specific portion of the mobile object does not contact the coordinate input surface.

As described in claim 11, the above mentioned distance detection unit comprises a distance determination signal detection unit receiving or transmitting a distance determination signal formed by ultrasonic waves or electromagnetic waves including light having directivity in a height direction of reception or transmission by the fixed object.

Thus, the present invention can provides the ultrasonic coordinate input apparatus capable of obtaining the position coordinates of an input pen using ultrasonic waves, determining whether the input pen contacts the handwriting surface or is held in the air and discriminating whether or not the input pen is within a predetermined distance valid in inputting if the input pen is in the air, and inputting not only the input surface contact locus of the input pen, but also the aerial movement locus.

Furthermore, the ultrasonic coordinate input apparatus according to the present invention changes the transmission cycle of infrared or ultrasonic waves based on the determination as to whether the input pen contacts the handwriting surface or is held in the air. Therefore, the change economically reduces the power consumption.

Furthermore, since the ultrasonic coordinate input apparatus can input the movement locus of the input pen which does not contact the handwriting surface without using electromagnetic induction, it is simple in structure, less expensive, and yet capable of inputting an aerial movement locus.

### BRIEF DESCRIPTION OF THE DRAWINGS

FIG. 1 shows the basic configuration and functions of the ultrasonic coordinate input apparatus according to the present invention;

FIG. 2A is a perspective view of the configuration of the input pen for use in the ultrasonic coordinate input apparatus according to the first embodiment of the present invention;

FIG. 2B is a block diagram of the configuration of its internal circuit;

FIG. 3A is a plan view of the receiver of the ultrasonic coordinate input apparatus according to the first embodiment of the present invention;

FIG. 3B is a front view of the receiver;

FIG. 3C is a side view of the receiver;

FIG. 4 is a practical explanatory view of the narrow directivity of the infrared sensor of the receiver in the vertical direction according to the first embodiment of the present invention;

FIG. 5 is a block diagram of the internal circuit of the receiver according to the first embodiment of the present invention;

FIGS. 6A and 6B show the waveform of the infrared pulse input into the infrared sensor and the waveform of the ultrasonic pulse input into the ultrasonic sensor of the receiver according to the first embodiment of the present invention;

FIG. 7A is a block diagram of the configuration of the internal circuit of the input pen of the ultrasonic coordinate input apparatus according to the second embodiment of the present invention;

FIG. 7B shows the configuration of its ultrasonic drive circuit;

FIG. 8 is a block diagram of the internal configuration of the receiver corresponding to the circuit configuration of the input pen according to the second embodiment of the present invention;

FIGS. 9A and 9B show the waveform of the infrared pulse input into the infrared sensor and the waveforms of the ultrasonic pulse input into the ultrasonic sensor of the receiver according to the second embodiment of the present invention;

FIG. 10 is a block diagram of the configuration of the input pen of the ultrasonic coordinate input apparatus according to the third embodiment of the present invention;

FIGS. 11A and 11B show a timing signal for detection of position coordinates output from the timer of the input pen according to the third embodiment of the present invention;

FIG. 12 is a block diagram of the internal configuration of the receiver corresponding to the circuit configuration of the input pen according to the third embodiment of the present invention;

FIG. 13 is a block diagram of the configuration of the internal circuit of the input pen of the ultrasonic coordinate input apparatus according to the fourth embodiment of the present invention;

FIG. 14 shows the relationship between the measured distance from the point of the input pen to the handwriting surface and the aerial effective range set in advance; and

FIG. 15 is a block diagram of the configuration of the internal circuit of the input pen of the ultrasonic coordinate input apparatus according to the fifth embodiment of the present invention.

### DESCRIPTION OF THE PREFERRED EMBODIMENTS

The embodiments of the present invention are described below by referring to the attached drawings. In the following explanation, the mobile object described in the claims comprises, for example, an input pen 1, etc., and a specific portion comprises, for example, a pen point 4, etc., a coordinate input surface comprises, for example, a handwriting surface 3, etc., a contact sensor unit comprises, for example, a pen touch switch 15, etc., a fixed object comprises, for example, a receiver 2, etc., a position sensor unit and a determination unit comprise, for example, an ultrasonic sensor 7, an infrared sensor 24, etc., a transmission unit comprises, for example, an ultrasonic transmitter 5, etc., an electromagnetic wave transmission unit comprises, for example, a infrared transmission device 6, an electromagnetic wave reception unit comprises, for example, a infrared sensor 24, etc., a timing acquisition unit comprises, for example, timers 27, 28, etc., a distance detection unit comprises, for example, a distance detection device 8, etc. and a distance determination signal transmission unit comprises, for example, a battery 11, a drive circuit 12, etc. to be replaced with the infrared sensor 24.

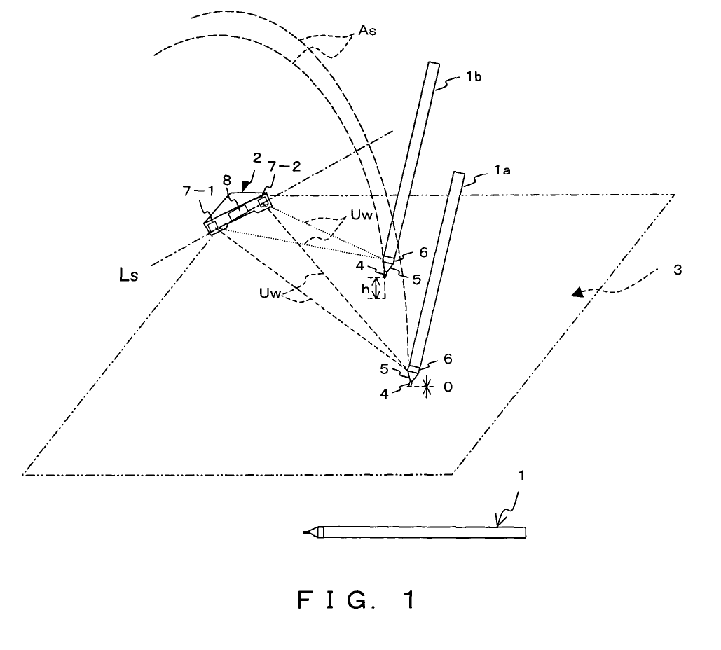

FIG. 1 shows the basic configuration and functions of the ultrasonic coordinate input apparatus according to the present invention. The ultrasonic coordinate input apparatus according to the present invention comprises the input pen 1 and the receiver 2 shown in FIG. 1. The receiver 2 is fixed at any of the four corners of the handwriting surface 3. The handwriting surface 3 can be any even and flat surface of a liquid crystal display, a tablet, a desk, a sheet of paper on the desk, etc.

The above mentioned receiver 2 is connected to a computer described later via cable or wireless system, and transmits the data of the contact input locus using the input pen 1 to the handwriting surface 3 or the data of the aerial input locus to the computer.

The point of the input pen 1 for use in inputting data either contacts the handwriting surface 3 as an input pen 1a being used as shown in FIG. 1 or is detached from the handwriting surface 3 as an input pen 1b being used as shown in FIG. 1.

Normally, when ultrasonic waves Uw are transmitted by the ultrasonic transmitter 5 from the input pen 1a or 1b to specify the position of the input pen 1a or 1b in the use state as shown in FIG. 1, only a three-dimensional position indicated by the arc As having the straight line Ls connecting two ultrasonic sensors 7-1 and 7-2 as the rotation axis can be specified.

That is, if the pen point 4 contacts the handwriting surface 3 as the input pen la being used as shown in FIG. 1, then the position of the pen point 4 corresponds to the intersection of the arc As and the handwriting surface 3. However, if the pen point 4 is held in the air as detached from the handwriting surface 3 by the distance h as shown in FIG. 1, then it is certain that the pen point 4 stays on the arc As, but its exact position on the arc As cannot be detected.

Therefore, the distance detection device 8 is provided for the receiver 2 in the ultrasonic coordinate input apparatus. The distance detection device 8 detects whether or not the pen point 4 is within a predetermined distance from the handwriting surface 3 (including the contacting state) by detecting the infrared transmitted from, for example, the infrared transmission device 6 of the input pen 1 within a predetermined range.

Based on the detection of the distance, the receiver 2 stops inputting the aerial movement locus when the distance from the pen point 4 of the input pen 1 to the handwriting surface 3 is longer than the above mentioned predetermined distance, and the aerial movement locus (or contact movement locus) is input based on the assumption that the pen point 4 of the input pen 1 stays in the air above the handwriting surface 3 (or contacts the handwriting surface 3) only when the distance from the pen point 4 of the input pen 1 to the handwriting surface 3 is equal to or shorter than the above mentioned predetermined distance.

The above mentioned input pen 1 is provided with a hold detection device for detecting the hold by a user. When the input pen 1 is configured as a battery-driven unit, and the input pen 1 constantly transmits ultrasonic waves, the ultrasonic transmitting operation requires relatively large power consumption, thereby shortening the life of the battery. Therefore, with the above mentioned configuration, the input pen 1 can be configured to transmit ultrasonic waves only when the hold of the input pen 1 by a user is detected (only while the pen is being used), thereby extending the life of the battery.

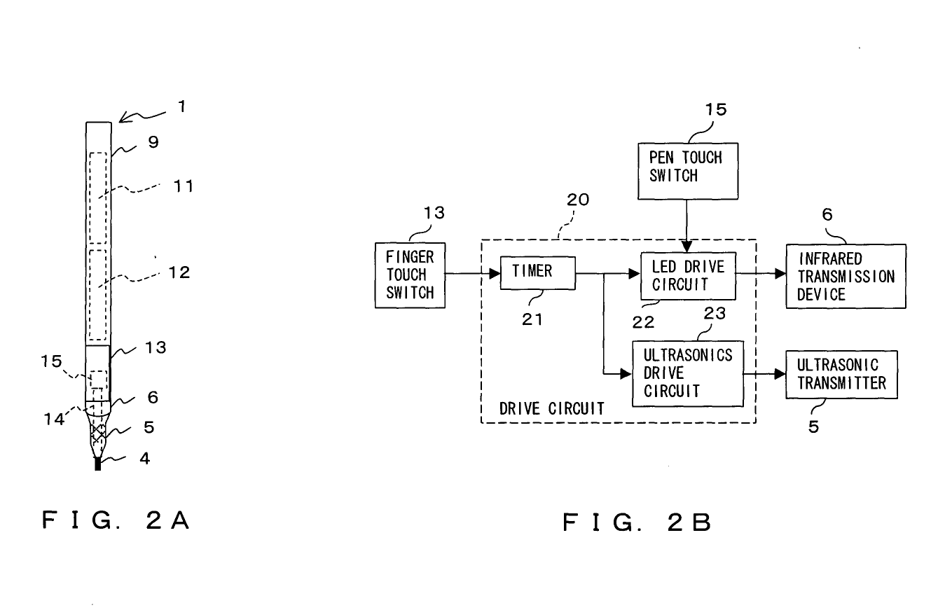

FIG. 2A is a perspective view of the configuration of the input pen for use in the ultrasonic coordinate input apparatus according to the first embodiment of the present invention. FIG. 2B is a block diagram of the configuration of its internal circuit. As shown in FIG. 2A, the input pen 1 comprises a cylinder 9, a battery 11 contained in the upper portion of the cylinder 9, a drive circuit 12 provided immediately below the battery 11, a finger touch switch 13 provided as adhered into a predetermined position of the holding portion below (closer to the pen point 4) the drive circuit 12, a internal shaft 14 operating with the pen point 4, the pen touch switch 15 connected to the upper end of the internal shaft 14, the infrared transmission device 6 comprising three infrared LEDs (light emitting diodes) mounted immediately below the holding portion, and the ultrasonic transmitter 5 provided cylindrically surrounding the thin end portion including the pen point 4 of the cylinder 9.

The finger touch switch 13 is a pressure-sensitive touch switch. When user's fingers hold the holding portion of the input pen 1, the electric resistance changes, thereby the holding the input pen 1 by the user detected.

The pen touch switch 15 is configured by a constantly open switch, and is closed when the pen point 4 contacts the handwriting surface 3 and is pushed upwards by the pen touch switch 15 which operates with the pen point 4. Thus, the contact of the pen point 4 with the handwriting surface 3 is detected.

Each of the three infrared LEDs of the infrared transmission device 6 has the distance of 120° and can transmit a predetermined infrared signal in the 360° direction as a total of the three LEDs. Thus, when the pen point 4 of the input pen 1 being used is within the predetermined distance from the handwriting surface 3, the infrared signal transmitted from the infrared transmission device 6 can be received by the receiver 2 however the input pen 1 being used is rotated.

Furthermore, the cylindrically mounted ultrasonic transmitter 5 is configured by, for example, a cylindrical piezoelectric film of polyvinylidene fluoride. The cylindrical configuration can transmit an ultrasonic signal having the directivity of 360°. Therefore, in this case, the ultrasonic signal transmitted from the ultrasonic transmitter 5 can be received by the receiver 2 however the input pen 1 being used is rotated.

If the input pen 1 is held by a user in inputting data, the hold is detected by the finger touch switch 13, and the detection signal is output to a timer 21 of an internal circuit 20 as shown in FIG. 2B. The timer 21 outputs a timing signal for detection of the position coordinates of the input pen 1 obtained by measuring a predetermined period to an LED drive circuit 22 and an ultrasonic drive circuit 23.

According to the timing signal, the LED drive circuit 22 drives the emission of the infrared transmission device 6 to transmit an infrared pulse signal on a predetermined cycle from the three infrared LEDs, and the ultrasonic drive circuit 23 drives the oscillation of the ultrasonic transmitter 5 to transmit an ultrasonic pulse signal on a predetermined cycle.

When the contact of the pen point 4 of the input pen 1 with the handwriting surface 3 is detected by the pen touch switch 15, the detection signal is output to the LED drive circuit 22 of the internal circuit 20 as shown in FIG. 2B. Upon receipt of the detection signal, the LED drive circuit 22 controls the infrared transmission device 6 to change the number of pulses of the infrared signal transmitted from the three infrared LEDs.

The finger touch switch 13 is not limited to a pressure-sensitive switch, but can be a switch whose electrostatic capacity changes by the contact with the hand of a user, or a mechanical switch to be pressed by the finger of a user. Additionally, the input pen 1 is horizontal placed when it is not in use, and is held obliquely when it is in use. Therefore, it can be determined whether or not it is in use by providing an obliqueness sensor for detecting the posture of the input pen 1.

However, if the input pen 1 is kept on a pen holder when it is not in use, then it is necessary to provide the pen holder with a device for nullifying the obliqueness sensor or the detection signal of the sensor.

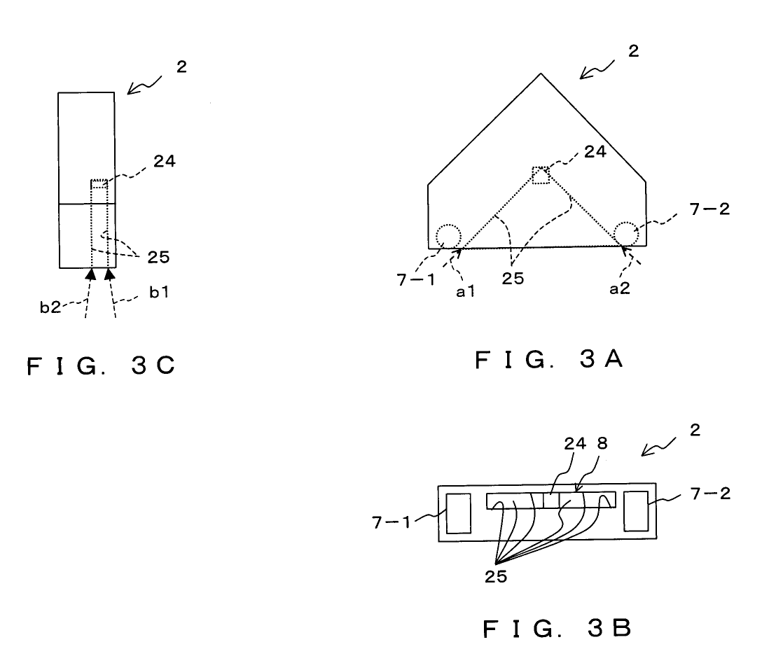

FIG. 3A is a plan view of the receiver 2 of the ultrasonic coordinate input apparatus according to the above mentioned first embodiment of the present invention. FIG. 3B is a front view of the receiver. FIG. 3C is a side view of the receiver. The plan view and the side view show the internal configuration in perspective formula using broken lines.

As shown in FIGS. 3A, 3B, and 3C, the receiver 2 comprises ultrasonic sensors 7-1 and 7-2 and the distance detection device 8 shown in FIG. 1. The distance detection device 8 comprises the infrared sensor 24 provided at the center in the receiver 2 and an infrared cutoff unit 25. The above mentioned ultrasonic sensors 7-1 and 7-2 are also configured by a cylindrical piezoelectric film of polyvinylidene fluoride, and can receive an ultrasonics signal transmitted from any direction to the receiver 2.

As shown in FIGS. 3A and 3B, the distance detection device 8 has upper and lower wide and shallow openings and a deep valley-shaped groove in the depth direction with the infrared sensor 24 provided at the bottom of the valley-shaped groove. The upper and lower surfaces of the groove and the side slopes forming the valley form the infrared cutoff unit 25. Thus, the photoreception characteristic of the infrared sensor 24 is the directivity within the range of 90° in the horizontal direction as indicated by the broken-line arrows a1 and a2 shown in FIG. 3A, and the directivity within the range of 10° in the vertical direction as indicated by the broken-line arrows b1 and b2 shown in FIG. 3C.

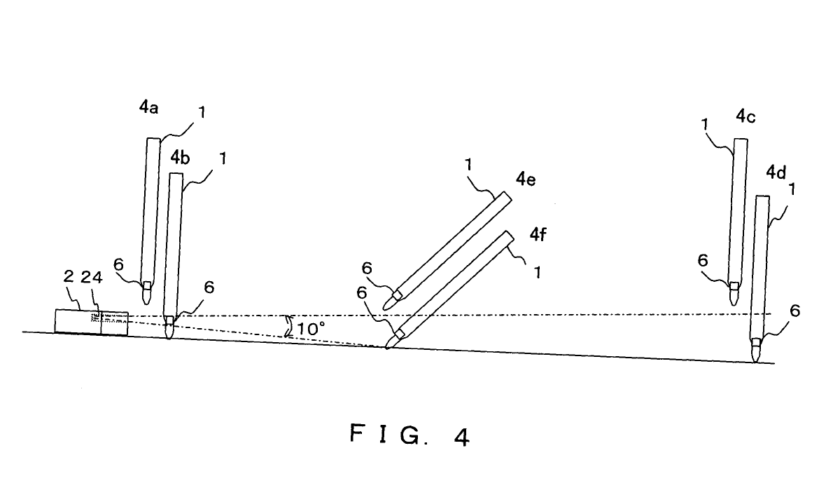

FIG. 4 practically shows the directivity of only 10° of the infrared sensor 24 in the vertical direction. In FIG. 4, since the infrared transmitted from the infrared transmission device 6 of the input pen 1 cannot be detected in the position of 4a, the aerial movement locus of the input pen 1 in the position of 4a cannot be input. If the input pen 1 is lowered down to the position of 4b, then the infrared transmitted from the infrared transmission device 6 is detected by the infrared sensor 24, and the aerial or contact movement locus of the input pen 1 is input.

Similarly, in the positions of 4c and 4d off the receiver 2 and 4e and 4f when the input pen 1 is oblique, the infrared pulse transmitted from the infrared transmission device 6 only in the positions of 4d or 4f in the range of the directivity of about 10° of the infrared sensor 24 is detected by the infrared sensor 24, and the aerial or contact movement locus of the input pen 1 is input according to the ultrasonic signal transmitted from the input pen 1 in synchronization with the infrared pulse.

On the other hand, in the positions of 4a, 4c, and 4e, the synchronization signal of the infrared pulse is not detected by the receiver 2. Therefore, the receiver 2 does not detect an ultrasonic pulse. As a result, the aerial movement locus of the input pen 1 is not input.

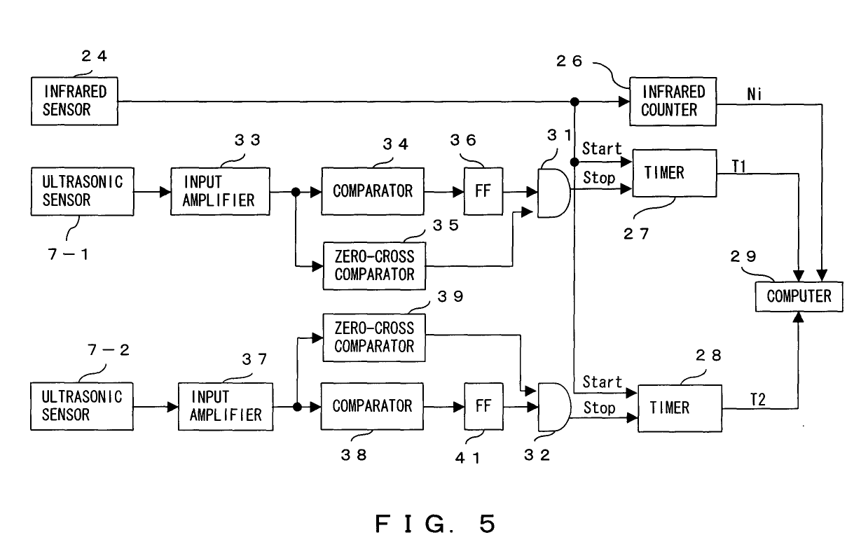

FIG. 5 is a block diagram of the internal circuit of the receiver 2. The infrared sensor 24 detects the infrared pulse, and the ultrasonic sensors 7-1 and 7-2 receive the ultrasonic pulse from the input pen 1. The infrared pulse detected by the infrared sensor 24 is input into an infrared counter 26, and the timers 27 and 28.

The infrared counter 26 counts the number of pulses of the input infrared pulses, and notifies a computer 29 of the detection signal Ni of the number of infrared pulse obtained by the count. The timer 27 starts the count in synchronization with the rising edge of the input infrared pulse, terminates the count according to the zero-cross detection signal input from an AND circuit 31 and described later, and notifies the computer 29 of the time data T1 from the start to the termination of the count. The other timer 28 starts the count in synchronization with the rising edge of the input infrared pulse, terminates the count according to the zero-cross detection signal input from an AND circuit 32 and described later, and notifies the computer 29 of the time data T2 from the start to the termination of the count.

The ultrasonic pulse received by the ultrasonic sensor 7-1 is amplified by an input amplifier 33, and input into a comparator 34 and a zero-cross comparator 35. The comparator 34 compares the input ultrasonic pulse with a predetermined threshold rt1 described later. If the amplitude of the ultrasonic pulse is equal to or larger than a threshold rt1, then the comparator 34 outputs a signal “true” to the above mentioned AND circuit 31 through a flip flop 36.

On the other hand, the zero-cross comparator 35 outputs “true” to the AND circuit 31 each time it detects a zero-cross of the ultrasonic pulse. When the signal “true” is input into both input terminals, the AND circuit 31 outputs the signal “true” to the timer 27 as a zero-cross detection signal.

Similarly, the ultrasonic pulse received by the ultrasonic sensor 7-2 is amplified by an input amplifier 37, and input into a comparator 38 and a zero-cross comparator 39. The comparator 38 compares the input ultrasonic pulse with a predetermined threshold rt2 described later, and outputs a signal “true” to the AND circuit 32 through a flip flop 41 when the amplitude of the ultrasonic pulse is equal to or larger than the threshold rt2.

On the other hand, the zero-cross comparator 39 outputs the signal “true” to the AND circuit 32 each time it detects a zero-cross of the ultrasonic pulse. When the signal “true” is input into both input terminals, the AND circuit 32 outputs the signal “true” as a zero-cross detection signal to the timer 28.

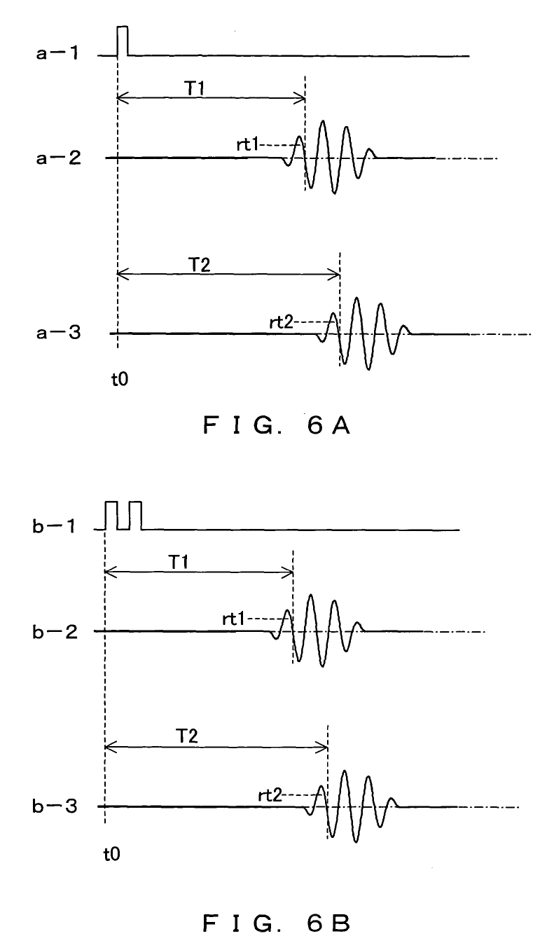

FIG. 6A shows a waveform of an infrared pulse input into the infrared counter 26 and counted, and transmitted to the computer 29, and a waveform of an ultrasonic pulse amplified by the timer 27 and input into the comparator 34 or 38, and the zero-cross comparator 35 or 39.

FIG. 6A shows an infrared signal a-1 transmitted from the infrared transmission device 6 of the input pen 1 when the pen point 4 of the input pen 1 contacts the handwriting surface 3, and ultrasonic signals a-2 an a-3 transmitted from the ultrasonic transmitter 5 of the input pen 1.

Furthermore, FIG. 6B shows an infrared signal b-1 transmitted from the infrared transmission device 6 of the input pen i when the pen point 4 of the input pen 1 is detached from the handwriting surface 3 and stays within a predetermined distance shown in FIG. 4 from the handwriting surface 3, and ultrasonic signals b-2 and b-3 transmitted from the ultrasonic transmitter 5 of the input pen 1. According to the present embodiment, the waveforms of the pulses of the ultrasonic signals a-2, a-3, b-2, and b-3 are displayed at different detection times or detection conditions, but are the same in waveform.

In FIG. 6A, the timers 27 and 28 shown in FIG. 5 are activated in synchronization with the rising time t0 of the edge of the pulse waveform of the infrared signal a-1, and start the count respectively at the time data T1 and the time data T2 as shown in FIG. 6.

The appropriate thresholds rt1 and rt2 shown in FIG. 6A are set in the comparators 34 and 38 shown in FIG. 5. The comparators 34 and 38 compares the values indicated by the pulse waveforms of the ultrasonic signals a-2 and a-3 whether or not they are larger than the thresholds rt1 and rt2 respectively. If yes, they outputs the signal “true” and turn on flip flops 31 and 32.

On the other hand, in parallel with the above mentioned processes, the zero-cross comparators 35 and 39 monitor the zero-cross of the pulse waveform of the ultrasonic signals a-2 and a-3. When they detect the zero-cross, the signal “true” is output.

By the logical product of the input from the flip flop 31 by the AND circuit 31 and the input from the zero-cross comparator 35, the zero-cross position after the threshold rt1 is exceeded is detected as the pulse attainment time of the ultrasonic signal a-2, and the zero-cross detection signal indicating the pulse attainment time of the ultrasonic signal a-2 is output from the AND circuit 31 to the timer 27, and the count by the timer 27 is stopped.

Thus, the ultrasonic propagation time T1 from the time t0 by the infrared synchronization signal (rising edge signal) to the reach of the ultrasonic pulse to the ultrasonic sensor 7-1 is detected by the timer 27, and transmitted to the computer 29.

Similarly, by the logical product of the input from the flip flop 41 by the AND circuit 32 and the input from the zero-cross comparator 39, the zero-cross position after the threshold rt2 is exceeded is detected as the pulse attainment time of the ultrasonic signal a-3, and the zero-cross detection signal indicating the pulse attainment time of the ultrasonic signal a-3 is output from the AND circuit 32 to the timer 28, and the count by the timer 28 is stopped.

Thus, the ultrasonic propagation time T2 from the time to by the infrared synchronization signal (rising edge signal) to the reach of the ultrasonic pulse to the ultrasonic sensor 7-2 is detected by the timer 28, and transmitted to the computer 29.

The above mentioned detection signal of the number of the infrared pulses by the infrared counter 26, the output value T1 indicating the pulse attainment time from the timer 27, and the output value T2 indicating the pulse attainment time from the timer 28 are transmitted to the computer 29 as described above. Then, the computer 29 performs processes based on the signal processing program. For example, it performs the processes of generating a contact movement locus to the handwriting surface 3, generating the aerial movement locus detached from the handwriting surface 3, etc.

According to the present embodiment, when the input pen 1 contacts the handwriting surface 3, one infrared pulse is generated as shown in FIG. 6A. When the input pen 1 is detached from the handwriting surface 3 and stays in the air, two infrared pulses are generated as shown in FIG. 6B. Thus, the computer 29 can recognize according to the detection signal of the number of infrared pulses transmitted from the infrared counter 26 whether the input pen 1 contacts or is detached from the handwriting surface 3. Furthermore, when the input pen 1 is detached from the handwriting surface 3 and stays in the air, the computer 29 can also recognize whether or not the pen point 4 of the input pen 1 is within a predetermined appropriate distance from the handwriting surface 3 for input of the aerial movement locus as shown in FIG. 4.

Furthermore, the system can also be configured such that the receiver 2 does not determine the timing (range of detecting the position of the input pen 1 in FIG. 4) of inputting an aerial movement locus, but a mechanical switch is provided on the input pen side, and the ultrasonic pulse is received only when the user presses the switch for detection of the coordinates of the aerial movement locus.

Described below is the method of obtaining the coordinates of the pen point 4 from the above mentioned ultrasonic propagation times T1 and T2 in the process of obtaining the coordinates of the movement locus of the input pen 1, that is, the pen point 4.

Assuming that the velocity of sound is V, the inter-receiver distance is W, the position of the pen point 4 of the input pen 1 is P, the position of the ultrasonic sensor 7-1 is R1, and the position of the ultrasonic sensor 7-2 is R2, and the distance from the position P to the position R1 is L1, and the distance from the position P to the position R2 is L2, the following equations hold.

L1=V×T1

L2=V×T2

Assuming that R1 indicates an origin, and R2 indicates (W,0) in a coordinate system, the coordinates (x, y) of the position P of the input pen 1 can be obtained as follows.

x²+y²=L1²

(x−W)²+y²=L2²

The values of x and y can be obtained as follows.

x=(L1²−L2²+W²)/2W

y=−sqrt(L1²−x²)

sqrt( ) means the square toot.

Thus, the coordinates of the position P of the input pen 1 can be obtained. Furthermore, when the handwriting surface 3 is assigned a unique coordinate system, the above mentioned coordinate system is moved, and rotation-converted.

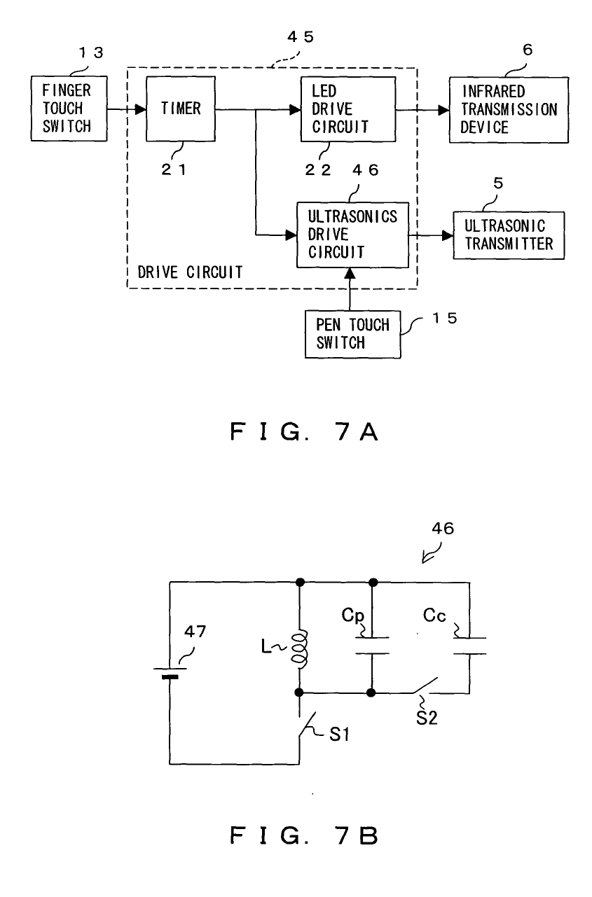

FIG. 7A is a block diagram of the configuration of the internal circuit of the input pen of the ultrasonic coordinate input apparatus according to the second embodiment of the present invention. FIG. 7B shows the configuration of the ultrasonic drive circuit. In FIG. 7A, the same constituents as the configuration shown in FIG. 2B are assigned the same reference numerals as those shown in FIG. 2B. With the configuration of an internal circuit 45 of the input pen according to the present embodiment, an ultrasonic drive circuit 46 is different in configuration from the ultrasonic drive circuit 23 shown in FIG. 2. Additionally, unlike the configuration shown in FIG. 2, the pen touch switch 15 is not connected to the LED drive circuit 22, but it is connected to the ultrasonic drive circuit 46 as shown in FIG. 7A.

In the above mentioned first embodiment, the discrimination of the contact state with the handwriting surface 3 from the detached state from the handwriting surface 3 is indicated by the number of infrared pulses transmitted from the input pen 1. However, according to the second embodiment, the infrared pulse is assumed to indicate only the transmission timing of an ultrasonic pulse, and the contact/detached state of the handwriting surface 3 is expressed by the frequency of ultrasonic waves.

Normally, the ultrasonic waves used in the coordinate input apparatus fall in the range of 40 to 100 kHz. In the present embodiment, based on the ultrasonic waves of 80 kHz, the frequency is modulated to indicate the contact/detached state with the handwriting surface 3.

The ultrasonic drive circuit 46 of the internal circuit 45 of the input pen 1 shown in FIG. 7A is configured by a coil L and a capacitor Cp connected in parallel with a battery supply 47 through a switch S1, and a capacitor Cc connected in parallel with them through a switch S2 as shown in FIG. 7B. The capacitor Cp is a piezoelectric device comprising a piezoelectric film, and forms the ultrasonics transmitter 5 shown in FIG. 7A. The capacitor Cc is a normal capacitor for correction.

In FIGS. 7A and 7B, each time the hold of the input pen 1 is detected by the finger touch switch 13, the timer 21 is activated, and a trigger on a predetermined cycle is input into the LED drive circuit 22 and the ultrasonic drive circuit 46, the LED drive circuit 22 drives the infrared transmission device 6 to control it to transmit an infrared pulse as shown in FIG. 6A from the infrared LED.

The ultrasonic drive circuit 46 has the switch S2 cooperating with the pen touch switch 15. When the pen point 4 of the input pen 1 contacts the handwriting surface 3, the switch S2 is closed in cooperation with the pen touch switch 15. Therefore, when the pen point 4 of the input pen 1 contacts the handwriting surface 3 and the switch S2 is closed, a resonant circuit comprising a coil L, a capacitor Cp, and a capacitor Cc is formed. Since the resonant circuit comprises two capacitors, it produces resonance of a rather long cycle.

Practically, the resonant frequency of the circuit is computed as follows.

1/[2πsqrt{L(Cp+Cc)}]

Therefore, when high-voltage resonance occurs, the ultrasonic waves of the frequency is generated from the piezoelectric film (capacitor Cp). In the present embodiment, the frequency is set approximately at 70 kHz.

On the other hand, when the pen point 4 of the input pen 1 is detached from the handwriting surface 3 and the switch S2 is open, a resonant circuit comprising only a coil L and a capacitor Cp is formed. Since the resonant circuit comprises only one capacitor, it produces resonance of a rather short cycle.

Practically, the resonant frequency of the cycle is computed as follows.

1/{2πsqrt(LCp)}]

Therefore, when high-voltage resonance occurs, the ultrasonic waves of the frequency is generated from the piezoelectric film (capacitor Cp). In the present embodiment, the frequency is set approximately at 100 kHz.

The switch S1 is turned on immediately before the ultrasonic waves are transmitted, a current flows gradually increasing in the coil L, and then a predetermined current flows through the coil L. At this time, when the current is shut off by opening the switch S1 by the trigger from the timer 21, a counter electromotive force occurs in the coil L, and a resonant high-voltage by the above mentioned resonant circuit occurs in the capacitor Cp comprising a piezoelectric film. As a result, ultrasonic waves of the above mentioned predetermined frequency (70 kHz or 100 kHz) are transmitted from the capacitor Cp, that is, an ultrasonic transmitter 17.

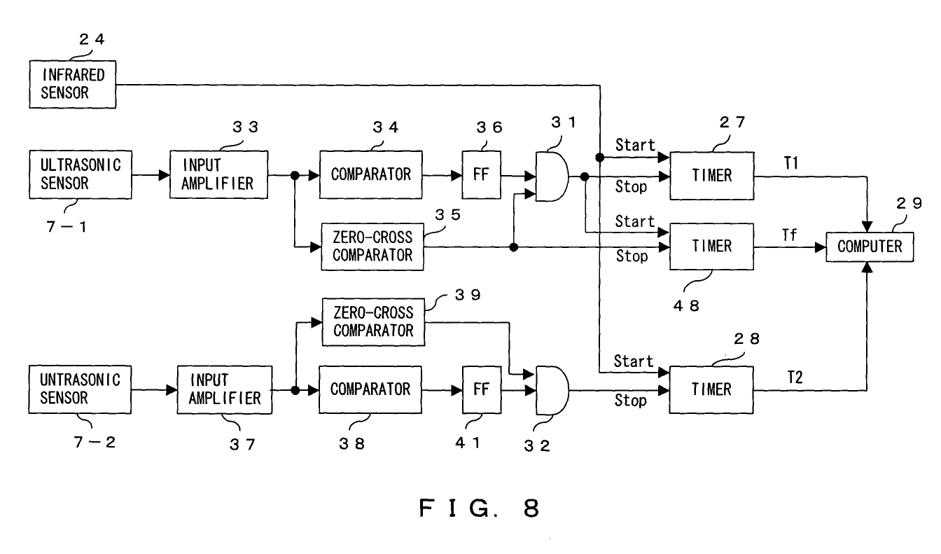

FIG. 8 is a block diagram of the internal configuration of the receiver 2 corresponding to the circuit configuration of the input pen 1. In FIG. 8, the same constituents as in FIG. 5 are assigned the same reference numerals as in FIG. 5. With the internal configuration of the receiver 2 the infrared counter 26 of the internal configuration shown in FIG. 5 is removed, and replaced with a timer 48.

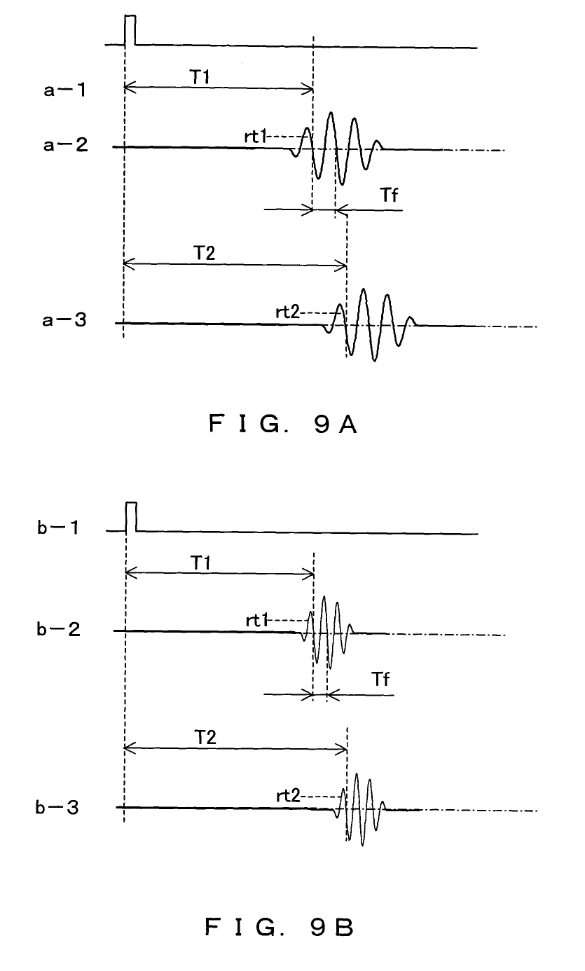

With the above mentioned configuration, FIGS. 9A and 9B show the waveform of the infrared pulse received by the infrared sensor 24 and input into the timers 27 and 28, and synchronously the waveform of the ultrasonic pulse transmitted from the input pen 1 and received by the ultrasonic sensors 7-1 and 7-2. FIG. 9A shows the waveform when the pen point 4 of the input pen 1 contacts the handwriting surface 3, and FIG. 9B shows the waveform when the pen point 4 of the input pen 1 is detached from the handwriting surface 3.

Also in the present embodiment, the synchronization signal of the infrared pulse received by the infrared sensor 24 as shown in FIG. 8 is input into the timers 27 and 28. However, since the infrared pulse is used only for the synchronization in this case, the pulse is output only once as shown by the infrared signal a-1 or b-1 shown in FIGS. 9A and 9B.

Furthermore, a series of operations from the ultrasonic sensor 7-2 to the timer 28 shown in FIG. 8 and the functions of the time data T2 output from the timer 28 to the computer 29 are the same as those shown in FIG. 5. Therefore, although the detection of the attainment time T2 of the ultrasonic pulse indicated by the ultrasonic signals a-3 and b-3 detected by the zero-cross comparator 39 shown in FIG. 8 and the threshold rt2 shown in FIGS. 9A and 9B shows a different frequency, it is similar to that with the ultrasonic signals a-3 and b-3 shown in FIGS. 6A and 6B.

The difference from the case shown in FIG. 5 is the operations of the zero-cross comparator 35 shown in FIG. 8 corresponding to the ultrasonic signal a-2 or b-2 shown in FIGS. 9A and 9B and detected by the ultrasonic sensor 7-1 shown in FIG. 8, and the newly added timer 48.

First, the ultrasonic pulse attainment detection signal detected by the zero-cross comparator 35 and the threshold rt1 and output from the AND circuit 31 stops the count of the timer 27, and starts the count of the timer 48. Thus, as indicated by the ultrasonic signal a-2 or b-2 shown in FIGS. 9A and 9B, the count of time Tf by the timer 48 starts at the ultrasonic pulse attainment time T1.

Then, as indicated by the zero-cross detection signal after the ultrasonic pulse is input from the zero-cross comparator 35 to the timer 48 as shown in FIG. 8, thereby stopping the count of time by the timer 48. Thus, as indicated by the ultrasonic signal a-2 or b-2 shown in FIGS. 9A and 9B, the time Tf of one cycle of the ultrasonic signal is detected, thereby computing the frequency of the ultrasonic waves.

As described above, when the pen point 4 of the input pen 1 contacts the handwriting surface 3, the cycle of the ultrasonic waves is long, and the frequency is as low as 70 kHz (refer to the ultrasonic signal a-2 shown in FIG. 9A). When the pen point 4 of the input pen 1 is detached from the handwriting surface 3, the cycle of the ultrasonic waves is short, and the frequency is as high as 100 kHz (refer to the ultrasonic signal b-2 shown in FIG. 9B). Thus, the computer 29 can determine whether the pen point 4 of the input pen 1 contacts the handwriting surface 3 or is detached from the handwriting surface 3.

It is obvious that, in this case, the directivity of the reception range of the infrared sensor 24 is the same as that shown in FIG. 4. Therefore, the ultrasonic pulse transmitted from the input pen 1 is also limited by a predetermined distance from the handwriting surface 3.

The system of discriminating by frequency the contact from the detachment with the handwriting surface of the input pen according to the present embodiment can be effectively applied to the system of obtaining the position of the input pen by only ultrasonic waves excluding infrared.

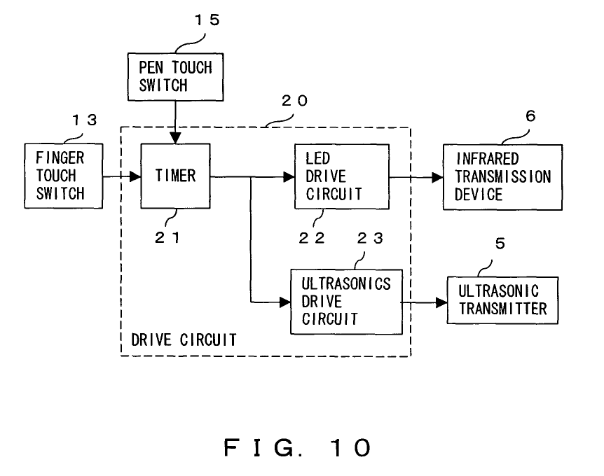

FIG. 10 is a block diagram of the configuration of the internal circuit of the input pen of the ultrasonic coordinate input apparatus in the third embodiment of the present invention. The configuration of the internal circuit 20 of the input pen 1 is the same as the configuration shown in FIG. 2B. However, the external pen touch switch 15 is not connected to the LED drive circuit 22 as shown in FIG. 2, but is connected to the timer 21 as shown in FIG. 10.

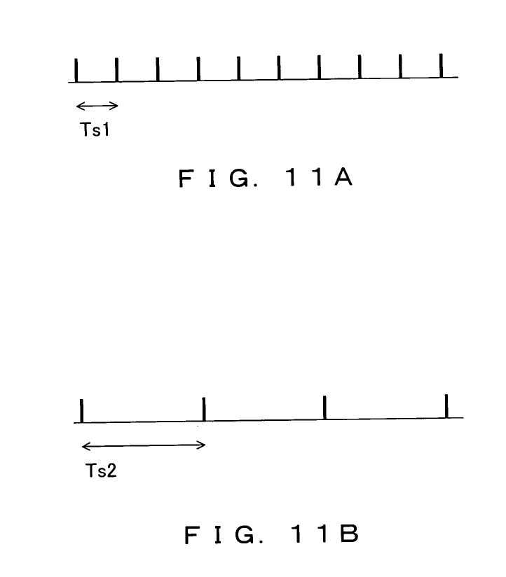

FIGS. 11A and 11B show the timing signal output from the timer 21. FIG. 11A shows the timing signal of the position coordinates sampling when the pen point 4 of the input pen 1 contacts the handwriting surface 3. FIG. 11B shows the timing signal of the position coordinates sampling when the pen point 4 of the input pen 1 is detached from the handwriting surface 3.

The interval Ts1 of the timing signal shown in FIG. 11A is, for example, 10 msec (millisecond), and the interval Ts2 of the timing signal shown in FIG. 11B is, for example, 30 msec. Thus, according to the third embodiment of the present invention, the contact state with the handwriting surface 3 is discriminated from the detached and aerial state with the handwriting surface 3 by changing the emission cycle Ts (Ts1, Ts2) of the infrared pulse.

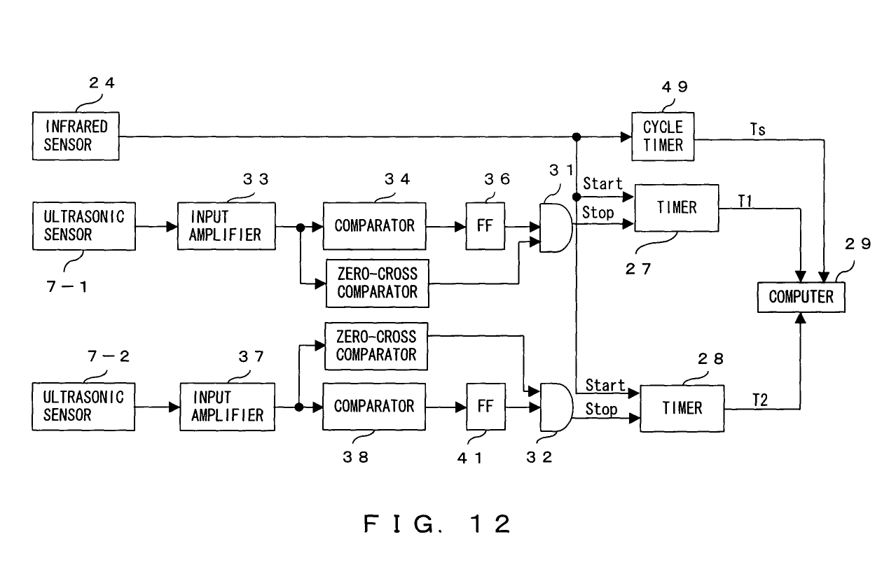

FIG. 12 is a block diagram of the internal configuration of the receiver 2 corresponding to the circuit configuration of the input pen 1. In FIG. 12, the same constituents as in FIG. 5 are assigned the same reference numerals as in FIG. 5. The internal configuration of the receiver 2 shown in FIG. 12 is different from the configuration shown in FIG. 5 in that a cycle timer 49 replaces the infrared counter 26 of the internal configuration shown in FIG. 5.

The cycle timer 49 counts the pulses of 100 Hz or 30 Hz shown in FIGS. 11A and 11B and input from the infrared sensor 24, and outputs the cycle Ts to the computer 29. The other operations and the time signals T1 and T2 output from the timers 27 and 28 to the computer 29 are the same as those in the case shown in FIGS. 6A and 6B.

As described above, according to the present embodiment, the interval of the infrared pulse generated depending on the presence/absence of the contact of the pen point 4 with the handwriting surface 3 by the pen touch switch 15 is variable. When handwriting is performed by the contact of the input pen 1 with the handwriting surface 3, a correct input locus is required. Therefore, the position coordinates are measured according to the time signals T1 and T2 at the interval Ts1 of 10 msec, that is, at the frequency of 100 Hz, as described above.

When an aerial movement locus is input, an error amount can be corrected until the contact is made with the handwriting surface 3, thereby not requiring high precision. Therefore, according to the present embodiment, the measurement interval of position coordinates is extended with the frequency reduced to the interval Ts2 of 30 msec, that is, 33 Hz. Generally, in inputting data by the input pen 1, since the time of writing in contact with the handwriting surface is shorter than the idling time in the air, the consumption of the battery can be considerably reduced by extending the sampling interval of the ultrasonic pulse of the aerial state.

The discrimination of the presence/absence of the contact of the pen point 4 with the handwriting surface 3 by the pen touch switch 15 is not only performed by variable intervals of the infrared pulses, but also performed by variable intervals of the ultrasonic pulses.

However, in this case, unlike the infrared, the ultrasonic waves vary in pulse intervals by the change in distance when, for example, the input pen 1 quickly moves on the handwriting surface 3, etc. Therefore, to vary the interval of pulses of two ultrasonic waves to discriminate the presence/absence of contact, the pulse interval is to be set such that change can be larger than the possible change of the pulse interval on the handwriting surface 3.

For example, when the significant range of the handwriting surface 3 is a 30 cm square, and when the input pen 1 moves from the distance of 0 to the distance of 30 cm at the above mentioned sampling, the attainment time of the ultrasonic pulse to the ultrasonic sensor changes by about 1 msec by the computation by “30 cm/velocity of sound”. Thus, 1 msec is the possible change of the ultrasonic pulse occurring on the handwriting surface 3.

Therefore, when the interval of two ultrasonic pulse is within 1 msec, the change of the position of the pen can be mistakenly detected as a change in pulse interval. As a result, if the pulse interval of the two ultrasonic pulses is extended to discriminate the presence/absence of the contact, then the above mentioned mistake can be avoided, thereby correctly detecting a change in pulse interval.

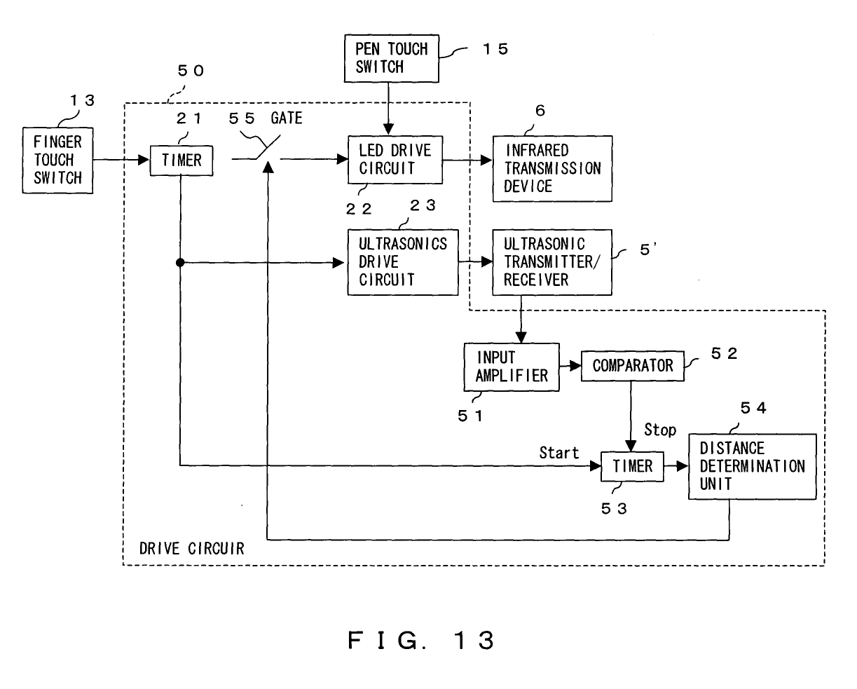

FIG. 13 is a block diagram of the configuration of the internal circuit of the input pen of the ultrasonic coordinate input apparatus according to the fourth embodiment of the present invention. In FIG. 13, the same constituents as in FIG. 2B are assigned the same reference numerals as in FIG. 2B.

In the present embodiment, the distance between the input pen 1 and the handwriting surface 3 is measured on the input pen side. A normal distance sensor can be used for the measurement. However, since the distance can be measured using the reflection of an ultrasonic pulse, a piezoelectric film used as the ultrasonic transmitter 5 in the input pen 1 is used as is. When the pen is held in the air, the piezoelectric film is used as an ultrasonic sensor after an ultrasonic pulse is transmitted from the point of the input pen 1, a reflected wave on the handwriting surface 3 is detected, the double distance is measured by the time from the transmission of the ultrasonic pulse to the return of the reflected wave, the measurement result is halved, and the distance from the pen point 4 of the input pen 1 to the handwriting surface is computed.

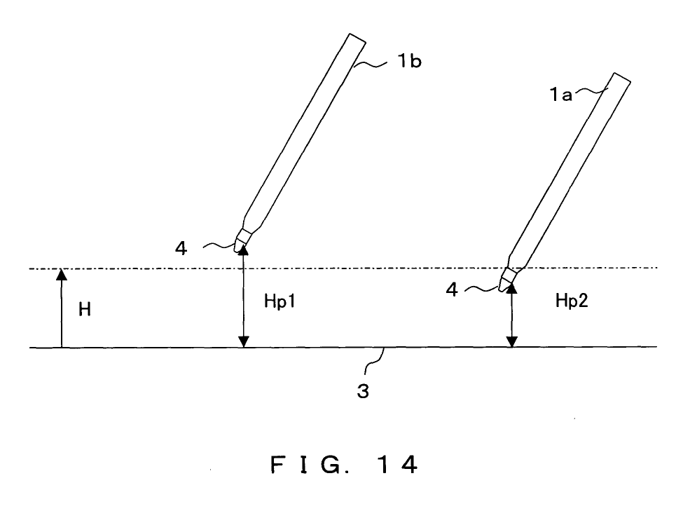

FIG. 14 shows the relationship between the measurement distance from the pen point 4 of the input pen 1 to the handwriting surface 3 and a predetermined aerial valid range. If the measured distance from the pen point 4 of the input pen 1 (1a, 1b) to the handwriting surface is longer than a predetermined valid distance H as in the case of the input pen 1b, then input (detection of position coordinates) is not performed. If the distance is equal to or smaller than the predetermined valid distance H, then the handwriting surface 3 is close, and the position coordinates of the normal input pen 1 are detected.

As shown in FIG. 13, an internal circuit 50 of the input pen 1 comprises an input amplifier 51, a comparator 52, a timer 53, and a distance determination unit 54 in addition to the configuration shown in FIG. 2B. Furthermore, a gate 55 for switching is provided between the timer 21 and the LED drive circuit 22. Furthermore, the ultrasonic transmitter 5 shown in FIG. 2B is changed in function, that is, functions as an ultrasonic transmitter/receiver 5′.

First, the ultrasonic drive circuit 23 and the timer 53 are activated according to a timing signal of a predetermined cycle from the timer 21. The timer 53 starts the count of time, and the ultrasonic drive circuit 23 drives the ultrasonic transmitter/receiver 5′ to transmit an ultrasonic pulse. The ultrasonic pulse is reflected by the handwriting surface 3, and the reflective pulse is received by the ultrasonic transmitter/receiver 5′, amplified by the input amplifier 51, and input into the comparator 52.

When the input signal indicates a value equal to or higher than a predetermined threshold, the comparator 52 detects the signal as a reflected wave of the ultrasonic pulse, and outputs the detection signal to the timer 53. Upon receipt of the detection signal, the timer 53 stops counting the time, and outputs the measured time data from the transmission of the ultrasonic pulse to the detection of the reflected wave to the distance determination unit 54. The distance determination unit 54 computes the distance from the pen point 4 of the input pen 1 to the handwriting surface based on the input measured time data, and compares the computed distance with the above mentioned predetermined valid distance H. If the computed distance is equal to or shorter than the valid distance, then it determines that the pen point 4 of the input pen 1 is close enough to the handwriting surface 3, closes the gate 55 and drives the infrared transmission device 6 by the LED drive circuit 22, and allows the infrared LED to generate the infrared pulse which is a timing signal for detection of the position coordinates.

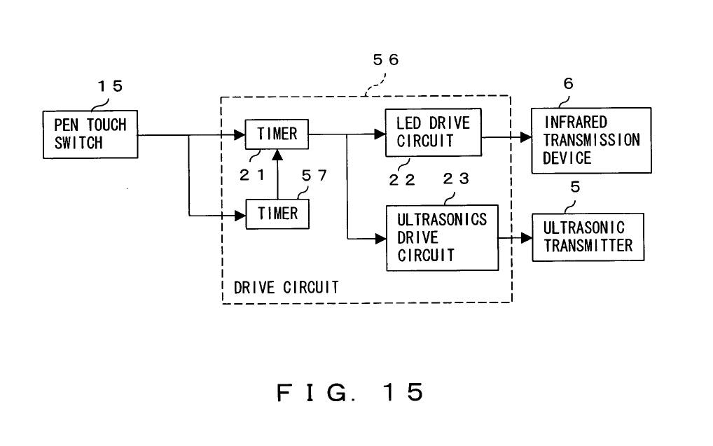

FIG. 15 is a block diagram of the configuration of the input pen of the ultrasonic coordinate input apparatus according to the fifth embodiment of the present invention. In FIG. 15, the same constituents as in FIG. 2B are assigned the same reference numerals as in FIG. 2B.

An internal circuit 56 shown in FIG. 15 removes the external finger touch switch 13 from the configuration shown in FIG. 2B, and adds a timer 57 into the circuit. When the pen point 4 of the input pen 1 of the internal circuit 56 contacts the handwriting surface 3 and a touch signal is once output from the pen touch switch 15, the timer 21 and the timer 57 are activated.

The timer 21 functions as in the other embodiments, and transmits an infrared pulse and an ultrasonic pulse from the infrared transmission device 6 and the ultrasonic transmitter 5 at a predetermined timing.

The other timer 57 counts a predetermined time set in advance. When the count terminates, it outputs an aerial transmission stop signal to the timer 21. When the pen point 4 contacts the handwriting surface 3 and a contact detection signal is input from the pen touch switch 15, the timer 21 does not stop, but continues outputting the timing signal. When the pen point 4 is held in the air and no contact detection signal is input from the pen touch switch 15, it stops outputting the timing signal.

Thus, within a predetermined time after the pen point 4 of the input pen 1 once contacts the handwriting surface 3, the receiver 2 detects the position coordinates regardless of the contact state or the detached aerial state of the input pen 1 with the handwriting surface 3.

For example, if the timer 57 is set for three minutes, and the input pen 1 once touches the handwriting surface 3, the aerial movement locus can e input for the subsequent three minutes. After the input pen 1 stays in the air for three minutes, inputting the position coordinates stops. Therefore, when the aerial input is to be continued, then the pen point 4 is to touch the handwriting surface 3 again (the pen point 4 is to pressed against any solid object such as a finger nail other than the handwriting surface 3), thereby restoring the input of the position coordinates. Since the finger touch switch 13 can be omitted, the configuration of the input pen 1 can be simpler and economical.

In this explanation, it is assumed that infrared pulses and ultrasonic pulses are all transmitted from the input pen 1, but the infrared pulses are not always transmitted from the input pen 1, but the distance detection device 8 of the receiver 2 can transmit the infrared pulses to the input pen 1. In this case, the distance detection device 8 is provided with the infrared LED having the directivity over 90° replacing the infrared sensor 24, and a transmission unit having three infrared sensors with the directivity of 120°, for example, replacing the infrared transmission device 6 of the input pen 1.

Also in this case, the range of the input pen 1 receiving an infrared timing signal from the distance detection device 8 is similar to that in the case shown in FIG. 4. The input pen 1 is to receive the infrared timing signal from the distance detection device 8, and transmits an ultrasonic signal. With the configuration, the input pen 1 only has to be provided with standby power for reception of an infrared timing signal, and transmit an ultrasonic signal only when it receives an infrared timing signal. Therefore, for example, when it is out of the movement locus range as shown by 4a, 4c, and 4e shown in FIG. 4, no ultrasonic signals are transmitted. In this method, the consumption of the battery 11 can be considerably reduced.

Similarly, the ultrasonic pulses are not always transmitted from the input pen 1. Since the ultrasonic transmitter of the input pen 1 and the ultrasonic sensor of the receiver 2 are piezoelectric devices, the transmission and the reception of ultrasonic waves can be switched only by changing the internal circuits. In this case, the time data indicating the distance is transmitted from the input pen 1 to the computer 29.

What is claimed is:

1. An ultrasonic coordinate input apparatus having a mobile object including an ultrasonic piezoelectric device for transmitting or receiving ultrasonic waves, a contact sensor unit for sensing contact between a specific portion of the mobile object and a coordinate input surface, a fixed object including at least two ultrasonic piezoelectric devices for receiving or transmitting ultrasonic waves, and a position sensor unit for obtaining a position of the mobile object relative to the fixed object based on a propagation time of the ultrasonic waves, comprising:
a determination unit determining whether or not the mobile object inputs coordinates when the specific portion of the mobile object does not contact the coordinate input surface; and
a transmission unit transmitting a signal as to whether or not the specific portion of the mobile object contacts the coordinate input surface from the mobile object to the fixed object.

2. The apparatus according to claim 1, wherein
said transmission unit modulates and transmits the ultrasonic waves depending on whether or not the specific portion of the mobile object contacts the coordinate input surface.

3. The apparatus according to claim 2, wherein
modulating the ultrasonic waves by said transmission unit is performed by changing a repetition cycle of the ultrasonic waves.

4. The apparatus according to claim 2, wherein
modulating the ultrasonic waves by said transmission unit is performed by changing a frequency of the ultrasonic waves.

5. The apparatus according to claim 1, further comprising:
an electromagnetic wave transmission unit transmitting electromagnetic waves including light in the mobile object;
an electromagnetic wave reception unit receiving electromagnetic waves including light in the fixed object; and
a timing acquisition unit obtaining a timing of generating the ultrasonic waves by transmission and reception of the electromagnetic waves, wherein
said electromagnetic wave transmission unit is configured such that the electromagnetic waves can be changed and transmitted depending on whether or not the specific portion of the mobile object contacts the coordinate input surface.

6. The apparatus according to claim 1, wherein
said determination unit comprises a timer counting a predetermined time from a time point of the specific portion of the mobile object contacting the coordinate input surface until a predetermined time passes, and coordinates are input by the mobile object although the specific portion of the mobile object does not contact the coordinate input surface on condition that the predetermined time is counted by the timer.

7. The apparatus according to claim 1, wherein
said determination unit comprises a hold detection device detecting the mobile object held by a hand of a user, and coordinates are input by the mobile object although the specific portion of the mobile object does not contact the coordinate input surface on condition that said hold detection device keeps the mobile object being held by a hand of a user.

8. The apparatus according to claim 7, wherein
said hold detection device is a touch switch provided for the mobile object.

9. The apparatus according to claim 7, wherein
said hold detection device is a posture detection sensor provided for the mobile object.

10. The apparatus according to claim 1, wherein
said determination unit comprises a distance detection unit detecting the distance between the mobile object and the coordinate input surface, and coordinates are input by the mobile object although the specific portion of the mobile object does not contact the coordinate input surface on condition that the distance detected by said distance detection unit is within a predetermined value.

11. The apparatus according to claim 10, wherein
said distance detection unit comprises a distance determination signal detection unit receiving or transmitting a distance determination signal formed by ultrasonic waves or electromagnetic waves including light having directivity in a height direction of reception or transmission by the fixed object.

12. The apparatus according to claim 11, wherein
directivity of the distance determination signal is formed by an electromagnetic waves shutoff object limiting the directivity in the height direction provided for the fixed object.

13. The apparatus according to claim 10, wherein
said distance detection unit comprises:
an ultrasonic transmission unit transmitting ultrasonic waves from the mobile object to the coordinate input surface; and
a reflected ultrasonic detection unit detecting, on the mobile object side, ultrasonic waves transmitted by said ultrasonic transmission unit and reflected by the coordinate input surface.
